(19) United States
(12) Patent Application Publication
(10) Pub. No.: US 2026/0290893 A1
(43) Pub. Date: Sep. 24, 2026

(54) SOLID POLYMER ELECTROLYTES WITH INCREASED POLYMER POLARIZABILITY FOR SOLID-STATE LITHIUM BATTERIES

(71) Applicant: FORD GLOBAL TECHNOLOGIES, LLC, Dearborn, MI (US)

(72) Inventors: Zijie Lu, Novi, MI (US); Xiaojiang Wang, Saline, MI (US); Andrew Robert Drews, Ann Arbor, MI (US); Venkataramani Anandan, Farmington Hills, MI (US)

(21) Appl. No.: 19/648,263

(22) Filed: Apr. 15, 2026

Related U.S. Application Data
(62) Division of application No. 17/398,419, filed on Aug. 10, 2021, now Pat. No. 12,633,568.

(51) Int. Cl. H01M 10/0565; C08K 5/315; C08K 5/435; H01M 10/0525

(52) U.S. Cl. CPC H01M 10/0565; C08K 5/315; C08K 5/435; H01M 10/0525; C08K 2201/001; H01M 2300/0082

(57) ABSTRACT

A solid polymer electrolyte having a reinforcing substrate, a polymer having ethylene oxide portions and hydrocarbon portions with pendent functional groups having high relative permittivity for an electrochemical cell is provided. The solid polymer electrolyte may provide good ionic conductivity at room temperature and good mechanical strength.

### CROSS-REFERENCE TO RELATED APPLICATIONS

This application is a division of U.S. application Ser. No. 17/398,419, filed Aug. 10, 2021, the disclosure of which is hereby incorporated in its entirety by reference herein.

### TECHNICAL FIELD

The present disclosure relates to electrolytes for electrochemical cells and more particularly to solid polymer electrolytes for lithium batteries.

### BACKGROUND

Advances to reduce dependence on fossil fuels and to use other energy sources are underway. However, many of these efforts require or rely on the storage of the energy sourced from the other methods. Electrochemical cells such as batteries are a primary method of storing such energy. Solid-state lithium batteries show great promise because they may be lightweight, flexible, and provide greater durability. Solid-state batteries include solid polymer electrolytes and many potential polymers have been proposed for this purpose. However, very few solid polymer electrolytes are commercially available because they may have many drawbacks such as cost, limitations on operating temperatures, limited conductivity, and poor mechanical strength. For example, poly(ethylene oxide) (PEO) based solid electrolytes with small molecule lithium salts have been proposed. However, they require operational temperatures exceeding the melting temperature of PEO (e.g., greater than 60° C.) and thus have low ionic conductivity (e.g., <10-5 S/cm) at room temperature (i.e., 25° C.). Further, high throughput methods of forming solid polymer electrolytes such as melt casting may contribute to crystallization which may further reduce ionic conductivity.

### SUMMARY

An electrolyte composition includes a reinforcing substrate for supporting a polymer having ethylene oxide portions and hydrocarbon portions with polar carbonyl groups. The polymer may be saturated with a plasticizer and have lithium ions from a small molecule lithium salt distributed throughout the polymer network. The electrolyte composition is configured to have an ionic conductivity of at least 10-3 mS/cm at 25° C.

A method of preparing an electrolyte composition is provided. The method includes mixing ethylene oxide monomer and alkene monomer having pendent functional groups with a relative permittivity of greater than 72 to form a first solution, mixing a plasticizer, a small molecule lithium salt, and a photoinitiator to form a second solution, mixing the first and second solutions to form a final solution, applying the final solution to a reinforcing substrate, and exposing the final solution to light irradiation. Thus providing a solid polymer electrolyte having an ionic conductivity of greater than 10-3 mS/cm.

An electrochemical cell including an anode, a cathode, and a solid polymer electrolyte therebetween is provided. The solid polymer electrolyte includes a solid polymer supported on a reinforcing or polymeric substrate and saturated by plasticizer. Lithium ions or lithium salt is dispersed within the polymer network and the polymer has poly(ethylene glycol) diacrylate based portions and vinylene carbonate based portions.

### BRIEF DESCRIPTION OF THE DRAWINGS

FIG. 1 is an electrochemical cell including a solid polymer electrolyte.

FIG. 2 is a solid polymer electrolyte.

FIG. 3 is schematic showing polymerization of the monomers for forming a solid polymer for a solid polymer electrolyte.

FIG. 4A is a cyclic voltammetry (CV) analysis and FIG. 4B is linear sweep voltammetry (LSV) analysis for a solid polymer electrolyte.

FIG. 5 is a lithium transference analysis of a solid polymer electrolyte.

FIG. 6 is interfacial resistance analysis between lithium and a solid polymer electrolyte.

FIG. 7 is thermal gravitational analysis of a solid polymer electrolyte.

FIGS. 8A and 8B are critical current density graphs for a solid polymer and a solid polymer electrolyte.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose implies the mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1 to 2.1 the following numbers 1.2, 1.3, 1.4, 1.5, 1.6, 1.7, 1.8, 1.9, and 2.0 can be selected as lower or upper limits.

The term “solid polymer electrolyte” is used herein to mean a polymer electrolyte that is solid at cell operating temperatures such as at room temperature (i.e., 25° C.), 40° C., or 80° C.

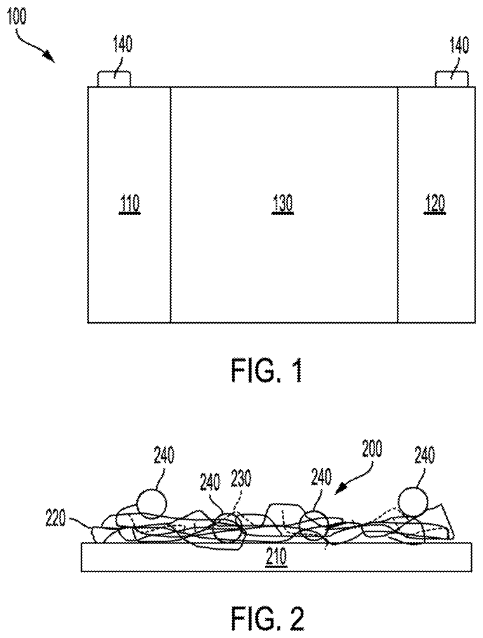

An electrochemical cell such as a lithium battery is provided. In FIG. 1, electrochemical cell 100 includes an anode (i.e., a negative electrode) 110, a cathode (i.e., a positive electrode) 120 and a solid polymer electrolyte 130 therebetween. The electrochemical cell may also include a current collector 140 and an additional separator between the anode 110 and cathode 120.

In FIG. 2, a solid polymer electrolyte 200 is provided. The solid polymer electrolyte 200 includes a solid polymer 220 deposited on or applied to a reinforcing substrate 210, a plasticizer 230, and lithium ions sourced from a small molecule lithium salt. The reinforcing substrate may be a porous or fiber mat (e.g., any suitable fiber such as glass fiber, carbon fiber, polymeric fiber including polytetrafluoroethylene (PTFE) or expanded polytetrafluoroethylene (ePTFE)). The reinforcing substrate 210 may contribute to superior mechanical properties and strength. PTFE or ePTFE may be a suitable reinforcing substrate at thinner thickness such as less than 150 μm, or more preferably less than 100 μm, or even more preferably less than 75 μm. In a variation, the reinforcing substrate may be 1 to 150 μm, or more preferably 25 to 100 μm, or even more preferably 50 to 70 μm. However, ePTFE, for example, may require surface treatments to improve wettability or may require additional processing to inject the solid polymer electrolyte into the reinforcing substrate. Glass fiber has good wettability for the solid polymer electrolyte but may require greater overall thickness. For example, a glass fiber reinforcing substrate may be used at greater than 100 μm, or more preferably greater than 125 μm, or even more preferably greater than 150 μm. In another variation, a solid polymer film of 50 to 500 μm, or more preferably 100 to 200 μm, or even more preferably 125 to 175 μm may be used. The solid polymer 220 may be saturated with or include a plasticizer 230 such as succinonitrile dispersed within it. The plasticizer may contribute to flexibility and reduce rigidity. Plasticizers such as succinonitrile may also improve ionic conductivity. Any suitable electrolyte plasticizer may be used. A lithium salt or source of lithium ions 240 such as a small molecule lithium salt may be dispersed within the polymer network. A small molecule lithium salt is used to refer to a salt with an anion size of less than 5 nm at its widest diameter, or more preferably less than 2 nm or even more preferably less than 1 nm or still further less than 0.8 nm in its desolvated state. For example, lithium bis(trifluoromethanesulfonyl)imide (LiTFSI) may be a suitable lithium salt. Other suitable salts may include but are not limited to LiPF6, LiClO4, LiBF4, or lithium bis(fluorosulfonyl)imide (LiFSI), or lithium bis(pentafluoroethanesulfonyl)imide (LiBETI).

The solid polymer 220 includes poly(ethylene oxide) (PEO) or ethylene oxide (EO) portions and hydrocarbon portions having other polar functional groups such as pendent carbonyl groups, carbonic acid groups, carbonic acid ester groups or cyclic carbonate. As such the degree of polarization can be altered by adjusting the ratio of the hydrocarbon portions having polar functional groups. Polarizability may be used to improve ionic conductivity in general and more specifically at room temperature. PEO portions may include 1 to 25, or more preferably 3 to 15, or even more preferably 6 to 8 ethylene oxide (EO) moieties. Glycols or EO containing monomers may be used to provide PEO portions. For example, poly(ethylene glycol) dimethacrylate (PEGDMA) or poly(ethylene glycol) diacrylate (PEGDA) may be used. In a refinement, the monomers may have a molecular weight of 100 to 2,000 g/mol, or more preferably 400 to 900 g/mol, or even more preferably 500 to 800 g/mol. Using monomers with greater molecular weights may increase flexibility and softness but may decrease room temperature conductivity. Conventionally, PEO based electrolytes rely solely on the coordination or interaction between lithium ions with the EO units which may be weaker than the interaction between lithium ions and other common polar groups such as water or alcohols. Further, crystallization during polymerization or processing may further weaken the interaction. In situ radical polymerization may be used to avoid crystallization, and more particularly light (e.g., UV) initiated polymerization may be used to avoid the temperature changes such as in melt casting which may facilitate crystallization. Increased polarizability also increases the interaction between the polymer chains and lithium ions thus improving ionic conductivity. Additional polar groups may be provided by polymerizing alkene monomers containing polar functional groups such as vinylene carbonate and/or maleic acid. In a refinement, alkene monomers containing a polar functional group with a relative permittivity (ε) greater than 30, or more preferably greater than 72, or even more preferably greater than 125 as measured by ASTM D3380 may be suitable. The solid polymer may be configured to include additional polar groups such that it provides superior ionic conductivity such as greater than 10-5 S/cm, or more preferably greater than 10-4 S/cm, or even more preferably greater than 10-3 S/cm at room temperature (i.e., 25° C.). The solid polymer electrolytes may have greater conductivity at higher temperature such as greater than 10-5 S/cm, or more preferably greater than 10-4 S/cm, or even more preferably 10-3 S/cm at 70° C. In a variation, up to 5% of the hydrocarbon containing a polar functional group, or more preferably up to 9%, or even more preferably up to 21% by weight of the electrolyte polymer may be incorporated. Unless indicated otherwise, percent by weight refers to the total aggregate weight of the polymer, the lithium salt, and plasticizer but does not include the weight of the reinforcing or polymeric substrate. In a refinement, the hydrocarbon containing polar functional group portions may be included at 1 to 40% or more preferably 5 to 25% or even more preferably 9 to 21% by weight. The mass ratio of ethylene oxide portions to hydrocarbon portions containing polar functional groups is from about 0.5:1 to 5:1, more preferably from 0.75:1 to 2.5:1, or even more preferably from 1:1 to 3:1. For example, the mass ratio may be 2.3:1 or in a refinement 1.5:1.

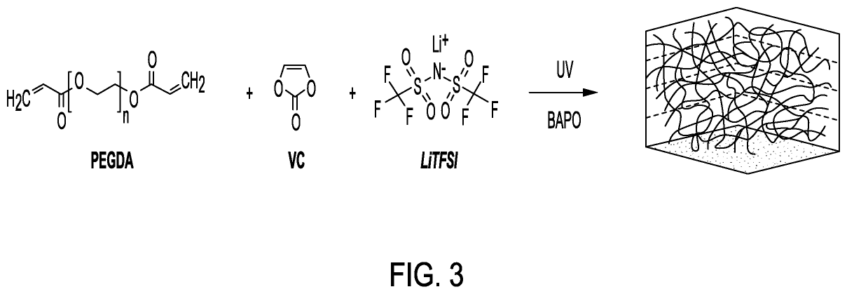

FIG. 3 provides a monomeric reaction for forming a suitable solid polymer of the solid polymer electrolyte. The monomers (i.e., PEO monomers and alkene monomers containing functional groups) may be added and mixed together to form a first solution. The first solution may be mixed at room temperature. A second solution may be made by mixing the plasticizer, small molecule lithium salt, and a photoinitiator such as phosphine oxide, phenyl bis(2,4,6-trimethylbenzoyl) or bis-acylphosphine oxide (BAPO). Other suitable photoinitiators may include but are not limited to 1-hydroxycyclohexylphenyl ketone (HCPK), 2-hydroxy-2-methyl-1-phenyl-1-propanone (HMPP), or diphenyl(2,4,6-trimethylbenzoyl)-phosphine oxide (TPO). An elevated temperature such as 65° C. may be necessary or assist in dispersing and/or dissolving the salt and initiator in the plasticizer but any suitable temperature for forming the second solution may be used. If heat is added it may not initiate the initiator at this stage. Depending on the specific initiator used, it may be necessary to protect the solution from light such as by using a dark or brown mixing container and/or shielding with a reflective material such as metal foil. The first solution may then be added to the second solution and mixed at an elevated temperature such as at 65° C. to form a final solution. The method is not particularly limited to adding the first solution to the second solution except that the protection from light may be maintained in the final mixing stages. The final solution may be applied to a non-adhering (non-stick) surface or applied to the reinforced substrate and then exposed to an appropriate wavelength irradiance such as UV or near-UV light for a predetermined amount of time. For example, a solution applied at 50 to 250 μm or more preferably 100 to 150 μm or even more preferably at 125 to 130 μm may be exposed to 365 to 405 nm light for at least 10 minutes. When applied to a non-adhering surface, the cured solid polymer may be removed and used in an electrochemical cell. When applied to the reinforcing substrate before curing into a solid polymer the resulting solid polymer electrolyte may be used in an electrochemical cell.

Electrolyte compositions may be prepared as shown in Table 1.

TABLE 1

| | Exemplary | 1 | 2 | 3 |
|---|---|---|---|---|
| Portion | Monomer | (wt. %) | (wt. %) | (wt. %) |
| Ethylene oxide portion | PEGDA | 1-80 | 5-65 | 10-55 |
| Hydrocarbon portion having | vinylene | 1-50 | 3-30 | 5-25 |
| polar functional groups | carbonate | | | |
| Small molecule lithium salt | LiTFSI | 5-70 | 15-55 | 25-45 |
| Plasticizer | succinonitrile | 1-70 | 10-60 | 20-50 |

The following examples in Table 2 were prepared following the method as provided above.

TABLE 2

| | | | | | Reinforcing/ |
|---|---|---|---|---|---|
| | Ethylene | Polar | | | polymeric |
| Example | Oxide | Monomer | Salt | Succinonitrile | substrate |
| 1a | 63% by wt. | — | 27% by wt. | — | — |
| | PEO₆₀₀ | | LiTFSI | | |
| 1b | 75% by wt. | — | 25% by wt. | — | — |
| | PEO (EO: | | LiTFSI | | |
| | Li = 20:1) | | | | |
| 2 | 35% by wt. | — | 30% by wt. | 35% by wt. | — |
| | PEGDA₅₇₅ | | LiTFSI | | |
| 3 | 49% by wt. | 21% by | 30% by wt. | — | — |
| | PEGDA₅₇₅ | wt. VC | LiTFSI | | |
| 4 | 42% by wt. | 18% by | 40% by wt. | — | — |
| | PEGDA₅₇₅ | wt. VC | LiTFSI | | |
| 5 | 24.5% by wt. | 10.5% by | 30% by wt. | 35% by wt. | — |
| | PEGDA₅₇₅ | wt. VC | LiTFSI | | |
| 6 | 21% by wt. | 9% by | 40% by wt. | 30% by wt. | — |
| | PEGDA₅₇₅ | wt. VC | LiTFSI | | |
| 7 | 21% by wt. | 9% by | 40% by wt. | 30% by wt. | ePTFE |
| | PEGDA₅₇₅ | wt. VC | LiTFSI | | |
| 8 | 15% by wt. | 10% by | 40% by wt. | 35% by wt. | glass fiber |
| | PEGDA₅₇₅ | wt. VC | LiTFSI | | |
| 9 | 28% by wt. | 12% by | 30% by wt. | 30% by wt. | glass fiber |
| | PEGDA₇₀₀ | wt. VC | LiTFSI | | |
| 10 | 21% by wt. | 9% by | 40% by wt. | 30% by wt. | glass fiber |
| | PEGDA₇₀₀ | wt. VC | LiTFSI | | |
| 11 | 14% by wt. | 6% by | 40% by wt. | 40% by wt. | glass fiber |
| | PEGDA₇₀₀ | wt. VC | LiTFSI | | |
| 12 | 21% by wt. | 9% by | 40% by wt. | 30% by wt. | glass fiber |
| | PEGDA₅₇₅ | wt. VC | LiTFSI | | |
| 13 | 21% by wt. | 9% by | 40% by wt. | 30% by wt. | ePTFE |
| | PEGDA₅₇₅ | wt. VC | LiTFSI | | |
| 14 | 34% by wt. | 40% by | 12% by wt. | 14% by wt. | glass fiber |
| | PEGDMA₅₀₀ | wt. VC | LiTFSI | | |
| 15 | 34% by wt. | 40% by | 12% by wt. | 14% by wt. | glass fiber |
| | PEGDMA₅₀₀ | wt. MA | LiTFSI | | |

Examples 1 and 2 are comparative examples of a conventional PEO based electrolyte and a plasticized PEO based electrolyte. Examples 3 and 4 represent solid polymers without plasticizer. Examples 5 and 6 represent solid polymers with plasticizer and examples 7 and 8 represent solid polymer electrolytes including an embodiment of the solid polymer described herein with plasticizer and a reinforcing substrate. Results for the examples are provided below in Table 2. Examples 9 through 11 represent the effect of changing the molecular weight of a monomer. Examples 12 and 13 show the effects of using a different reinforcing substrate. Example 14 uses a different ethylene oxide containing monomer and example 15 incorporates a different monomer containing polar groups.

TABLE 3

| | Conductivity | Electrochemical | Li⁺ | CCD | |
|---|---|---|---|---|---|
| Example | at RT (S/cm) | Window (V) | Transference | (mA/cm²) | Visual Observation/thickness |
| 1a | 6.25 × 10⁻⁶ | — | — | — | Self-standing membrane; 200 μm |
| 1b | 5.00 × 10⁻⁶ | 5.5 | 0.2 | — | 150 μm |
| 2 | 5.16 × 10⁻⁵ | 4.6-4.8 | — | — | Clear membrane; 350 μm |
| 3 | 5.24 × 10⁻⁵ | 4.6-4.8 | — | — | Strong membrane; light |
| | | | | | yellow color, 350 μm |
| 4 | 8.53 × 10⁻⁵ | 4.6-4.8 | — | — | Strong membrane; light |
| | | | | | yellow color, 300 μm |
| 5 | 5.98 × 10⁻⁴ | 4.6-4.8 | — | 0.2 | Strong membrane; light |
| | | | | | yellow color, 145 μm |
| 6 | 4.69 × 10⁻⁴ | 4.6-4.8 | 0.33 | 0.2 | Clear membrane; 145 μm |
| 7 | 2.27 × 10⁻⁴ | 4.6-4.8 | — | — | Flexible membrane; 150 μm |
| 8 | 5.64 × 10⁻⁴ | 4.6-4.8 | — | >0.5 | Tacky membrane; 250 μm |
| 9 | 2.30 × 10⁻⁴ | 5.0 | 0.33 | 0.25 | 150 μm |
| 10 | 3.60 × 10⁻⁴ | 4.9 | 0.35 | 0.25 | 150 μm |
| 11 | 9.70 × 10⁻⁴ | 4.7 | 0.45 | 0.5 | 150 μm |
| 12 | 1.80 × 10⁻⁴ | 4.8 | 0.38 | — | 150 μm |
| 13 | 2.30 × 10⁻⁴ | 4.7 | 0.23 | — | 60 μm |
| 14 | 1.60 × 10⁻⁴ | 4.7 | 0.38 | — | 150 μm |
| 15 | 0.80 × 10⁻⁴ | 4.7 | 0.38 | | 150 μm |

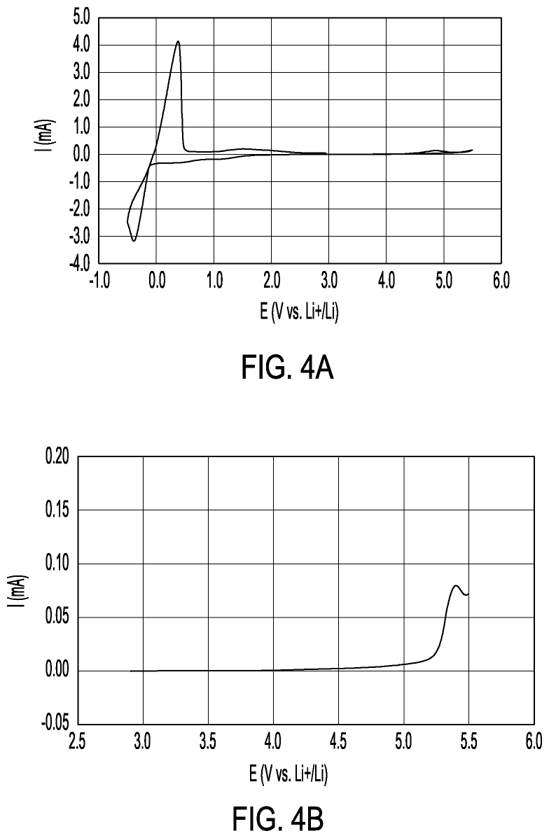

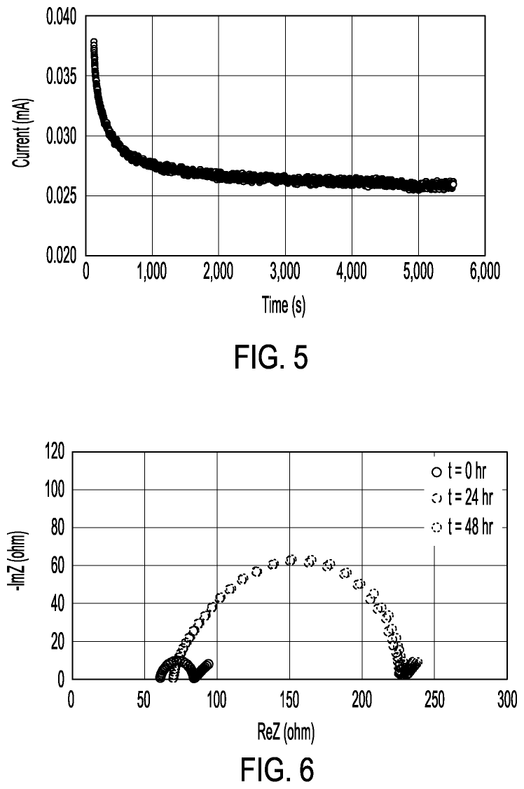

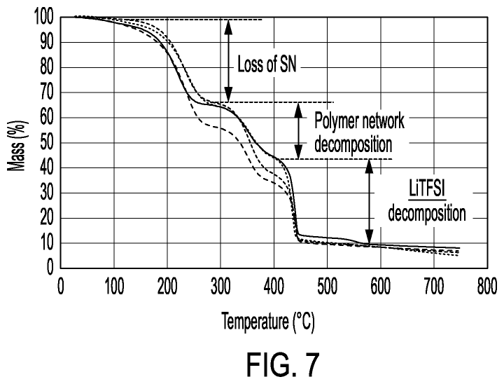

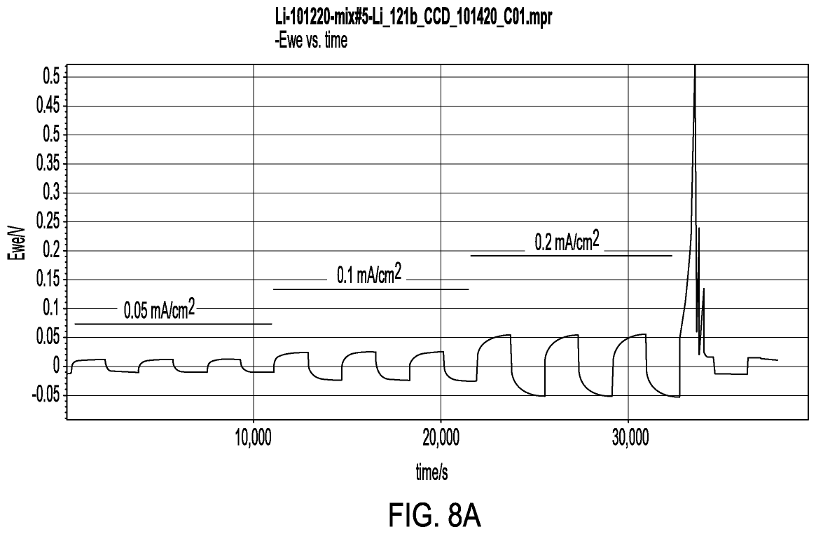

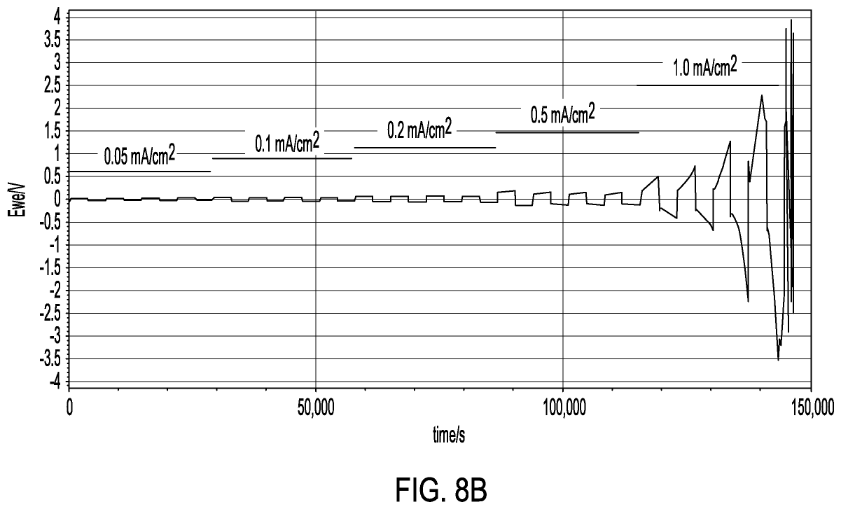

As shown in table 3 the suitable electrochemical window (i.e., 4.6-4.8) was determined by cyclic voltammetry and linear sweep voltammetry analysis as shown in FIGS. 4A and 4B. The lithium ion transference was 0.33 as shown in FIG. 5, which is similar to conventional PEO based solid polymer electrolytes. A small stable interfacial resistance between lithium and the solid polymer electrolytes disclosed herein was witnessed as shown in FIG. 6. The thermal analysis (TGA) of the solid polymer electrolytes described herein was conducted. Thermal stability was witnessed up to 150° C. Between 150 and 250° C. the plasticizer was lost and between 250 and 400° C. polymer decomposition was witnessed as shown in FIG. 7. The current density for examples 5 and 6 was low due to a suspected tear in the polymer film as shown in FIG. 8A but this was improved to greater than 0.5 mA/cm² when a reinforced substrate was used as shown in FIG. 8B.

Additional testing is provided for examples 9 through 11 as shown in Table 4.

TABLE 4

| | Conductivity | Eₐ at | Rᵢ of Li/ | |
|---|---|---|---|---|
| | at 70° C. | 60° C. | SPE interface | T_{g} at |
| Example | (S/cm) | (kJ/mol) | (Ohm.cm²) | 25° C. |
| 1a | 7.00 × 10⁻⁴ | 38.76 | 350 | −41 |
| 9 | 1.14 × 10⁻³ | 29.6 | 105 | −69 |
| 10 | 2.54 × 10⁻³ | 34.43 | 90 | −62 |
| 11 | 4.11 × 10⁻³ | 26.45 | 70 | <−80 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electrolyte composition comprising:
a reinforcing substrate;
a polymer supported by the reinforcing substrate, the polymer having ethylene oxide portions and hydrocarbon portions having carbonic acid groups, the ethylene oxide portions to hydrocarbon portions having a mass ratio from about 0.5:1 to 5:1;
a plasticizer distributed within the polymer; and
lithium ions from a small molecule lithium salt distributed within the polymer and plasticizer;
wherein the electrolyte composition is configured to have an ionic conductivity of at least 10-3 mS/cm at 25° C.

2. The electrolyte composition of claim 1, wherein the ethylene oxide portions are poly(ethylene glycol) diacrylate based.

3. The electrolyte composition of claim 2, wherein the hydrocarbon portions with carbonic acid groups is vinylene carbonate based.

4. The electrolyte composition of claim 3, wherein the plasticizer is succinonitrile.

5. The electrolyte composition of claim 4, wherein the small molecule lithium salt is lithium bis(trifluoromethanesulfonyl)imide.

6. The electrolyte composition of claim 5, wherein the reinforcing substrate is glass fiber.

7. The electrolyte composition of claim 5, wherein the reinforcing substrate is a polymeric substrate.

8. The electrolyte composition of claim 7, wherein the polymeric substrate is expanded polytetrafluoroethylene.

9. The electrolyte composition of claim 1, wherein the carbonic acid groups are carbonic acid ester groups.

10. An electrochemical cell comprising:
an anode;
a cathode; and
a solid polymer electrolyte between the anode and cathode, the solid polymer electrolyte having a polymer supported by a substrate, a plasticizer dispersed within the polymer and a lithium ion sourced from a small molecule lithium salt, the polymer having poly(ethylene glycol) diacrylate based portions and vinylene carbonate based portions.

11. The electrochemical cell of claim 10, wherein the plasticizer is succinonitrile.

12. The electrochemical cell of claim 11, wherein the small molecule lithium salt is lithium bis(trifluoromethanesulfonyl)imide.

13. The electrochemical cell of claim 12, wherein the substrate is a glass fiber reinforcing substrate.

14. The electrochemical cell of claim 12, wherein the substrate is a polymeric substrate.

15. The electrochemical cell of claim 14, wherein the polymeric substrate is expanded polytetrafluoroethylene.
